(19) United States
(12) Patent Application Publication
(10) Pub. No.: US 2026/0086766 A1
(43) Pub. Date: Mar. 26, 2026

(54) VOLUME ADJUSTMENT METHOD, ELECTRONIC DEVICE AND STORAGE MEDIUM

(71) Applicant: Beijing Zitiao Network Technology Co., Ltd., Beijing (CN)

(72) Inventor: Ye MA, Beijing (CN)

(21) Appl. No.: 19/336,280

(22) Filed: Sep. 22, 2025

(30) Foreign Application Priority Data
Sep. 23, 2024 (CN) 202411330753.9

(51) Int. Cl. G06F 3/16; G06N 7/01

(52) U.S. Cl. CPC G06F 3/165; G06N 7/01

(57) ABSTRACT

A volume adjustment method and apparatus, electronic device, and storage medium are provided. The volume adjustment method includes: obtaining target media data and media metadata corresponding to the target media data; obtaining a volume adjustment probability of playing the target media data according to a preset volume corresponding to the target media data, wherein the volume adjustment probability is obtained based on a regression processing result of the media metadata; and adjusting the preset volume based on the volume adjustment probability, to determine a volume to play the target media data.

### CROSS-CITATION TO RELATED APPLICATION

This application claims the priority to and benefits of the Chinese Patent Application, No. 202411330753.9, which was filed on Sep. 23, 2024. The aforementioned patent application is hereby incorporated by reference in its entirety.

### TECHNICAL FIELD

The present disclosure relates to the technical field of computer processing, and particularly relates to a volume adjustment method and apparatus, electronic device, storage medium, and product.

### BACKGROUND

In the related art, when media data is played by a terminal, an equalization processing is performed to ensure the equalization of playback loudness when played by the terminal.

### SUMMARY

The present disclosure provides a volume adjustment method and apparatus, electronic device, storage medium, and product, to solve the problem that the volume needs to be manually adjusted by the user when playing media data.

In a first aspect, the present disclosure provides a volume adjustment method, comprising:
obtaining target media data and media metadata corresponding to the target media data;
obtaining a volume adjustment probability of playing the target media data according to a preset volume corresponding to the target media data, wherein the volume adjustment probability is obtained based on a regression processing result of the media metadata; and
adjusting the preset volume based on the volume adjustment probability, to determine a volume to play the target media data.

In a second aspect, the present disclosure provides a volume adjustment apparatus, comprising:
a first obtaining module, configured to obtain target media data and media metadata corresponding to the target media data;
a first processing module, configured to obtain a volume adjustment probability of playing the target media data according to a preset volume corresponding to the target media data, wherein the volume adjustment probability is obtained based on a regression processing result of the media metadata; and
an adjustment module, configured to adjust the preset volume based on the volume adjustment probability to determine a volume to play the target media data.

In a third aspect, the present disclosure provides an electronic device, comprising: a processor; and a memory, configured to store computer instructions, wherein the computer instructions, when executed by the processor, cause the processor to perform the volume adjustment method of the first aspect or any corresponding embodiment described above.

In a fourth aspect, the present disclosure provides a computer-readable storage medium, wherein computer instructions are stored on the computer-readable storage medium, and the computer instructions, when executed by a computer processor, cause the computer processor to perform the volume adjustment method of the first aspect or any corresponding embodiment described above.

In a fifth aspect, the present disclosure provides a computer program product comprising computer instructions, wherein the computer instructions, when executed by a computer, cause the computer to perform the volume adjustment method of the first aspect or any corresponding embodiment described above.

### BRIEF DESCRIPTION OF DRAWINGS

To describe the technical solutions in the embodiments of the present disclosure or in the prior art more clearly, the accompanying drawings required in the description of the embodiments or the prior art will be described briefly below. Apparently, the accompanying drawings in the following description are some embodiments of the present disclosure, and other accompanying drawings can also be derived from these drawings by those ordinarily skilled in the art without creative efforts.

FIG. 1 is a schematic flowchart of a volume adjustment method according to an embodiment of the present disclosure.

FIG. 2 is a schematic flowchart of a method for training a target volume adjustment probability model according to an embodiment of the present disclosure;

FIG. 3 is a schematic flow diagram of another volume adjustment method according to an embodiment of the present disclosure;

FIG. 4 is a schematic flow diagram of yet another volume adjustment method according to an embodiment of the present disclosure;

FIG. 5 is a structural block diagram of a volume adjustment device according to an embodiment of the present disclosure;

FIG. 6 is a schematic diagram of a hardware structure of an electronic device according to an embodiment of the present disclosure.

### DETAILED DESCRIPTION

In order to make the purpose, technical solutions, and advantages of the embodiments of the present disclosure more clear, the technical solutions in the embodiments of the present disclosure will be clearly and completely described below with reference to the accompanying drawings in the embodiments of the present disclosure, and it is obvious that the described embodiments are part of the embodiments of the present disclosure, but not all the embodiments. Based on the embodiments in the present disclosure, all other embodiments obtained by those skilled in the art without making creative efforts belong to the scope of protection of the present disclosure.

In the related art, when media data is played by a terminal, equalization processing is performed to ensure the equalization of playback loudness when played by the terminal side. However, in the actual playback process, the loudness corresponding to the playback volume of some media data will not meet the user's needs, and then the user needs to manually increase or decrease the volume, thus affecting the user's experience.

In view of this, an embodiment of the present disclosure provides a volume adjustment method, which can effectively reduce the number of times that the volume adjustment needs to be performed when media data is played, and thus achieve the purpose of improving the playing effect of media data.

According to an embodiment of the present disclosure, there is provided an embodiment of a volume adjustment method, and it should be noted that steps illustrated in the flowchart of the drawings may be executed in a computer system such as a set of computer-executable instructions, and although a logical sequence is illustrated in the flowchart, in some cases, the steps illustrated or described may be executed in an order different from that herein.

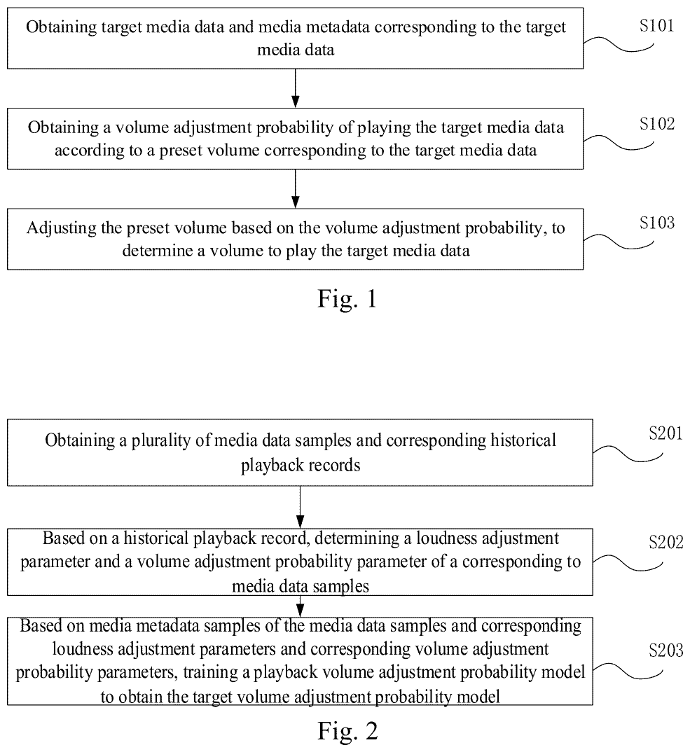

In this embodiment, a volume adjustment method is provided, which is applicable to an electronic device, such as mobile phones, tablet computers, etc. FIG. 1 is a flowchart of a volume adjustment method according to an embodiment of the present disclosure, and as shown in FIG. 1, the flow comprises the following steps:
Step S101: obtaining target media data and media metadata corresponding to the target media data.

Here, the target media data may be understood as any media data to be played. For example, the target media data may be audio or video to be played.

In order to understand the pertinent information of the target media data, while obtaining the target media data, the media metadata corresponding to the target media data is obtained together, so as to clarify the media information related to the target media data according to the media metadata, thereby facilitating subsequent targeted processing and improving the reliability of volume adjustment. The media metadata comprises, but is not limited to, the following various media information of the target media data: a corresponding media source loudness, a loudness range, a starting loudness of the loudness range, an end loudness of the loudness range, a maximum instant loudness, a maximum short-term loudness, a first low-frequency direct speaker compensation gain (for example, 100 hz), a second low-frequency direct speaker compensation gain (for example, 150 hz), a third low-frequency direct speaker compensation gain (for example, 200 hz), a total playback duration, and a target loudness, etc.
Step S102: obtaining a volume adjustment probability of playing the target media data according to a preset volume corresponding to the target media data.

The volume adjustment probability is obtained based on a regression processing result of the media metadata. The preset volume refers to the initial playback volume that the target media data is preset before volume adjustment is performed. Regression processing is a data analysis method used to study the relationship between two or more variable by establishing a mathematical model. By taking the probability of volume adjustment as dependent variable, taking the media metadata of the target media data as independent variable, and taking the volume adjustment probability of the target media data playing according to different preset volumes as dependent variable for regression processing, the relationship between the volume adjustment probability and the target media data may be fully mined, and then based on the regression processing result of the media metadata, the volume demand corresponding to the target media data can be better evaluated, so that the volume adjustment probability may be performed when the target media data is played according to the preset volume can be analyzed according to the obtained regression processing result, and the occurrence of blind volume adjustment can be effectively avoided, and the purpose of improving the rationality and accuracy of volume adjustment can be achieved.
Step S103: adjusting the preset volume based on the volume adjustment probability, to determine a volume to play the target media data.

According to the obtained volume adjustment probability, it is possible to clarify whether or not the preset volume is adjusted. If the probability is high, it indicates that the target media data needs to adjust the preset volume; If the probability is low, it indicates that the target media data does not need to adjust the preset volume.

The volume adjustment based on the volume adjustment probability may make the volume to be played determined after the adjustment more in line with the playing expectation, effectively reduce the probability that the volume of the target media data is adjusted in the playing process, and thus is beneficial to the purpose of improving the playing effect of the media data.

The volume adjustment method according to the present embodiment determines the volume adjustment probability of playing the target media data according to the corresponding preset volume based on the media metadata corresponding to the target media data, so that the volume adjustment process can be more targeted, and the obtained volume to be played can be more in line with the playing expectation, and the probability that the volume of the target media data is adjusted during the playing process can be effectively reduced, thereby achieving the purpose of improving the playing effect of the media data.

In some alternative embodiments, the volume adjustment probability is determined based on a preset target volume adjustment probability model, and the target volume adjustment probability model is trained based on regression processing of historical playback records of a plurality of media data samples. That is, the model training of regression processing is performed in advance through the historical playback records of a large number of media data samples to learn the regression relationship between media data and volume adjustment under different preset volumes, and then the target volume adjustment probability model used for performing volume adjustment probability prediction may be obtained. Thus, in practical application, the volume adjustment probability corresponding to the target media data can be determined through the pre-trained target volume adjustment probability model, which can improve the determination efficiency, promote the volume adjustment efficiency, and reduce the occurrence of manual volume adjustment by users, thus being beneficial to improving the volume adjustment performance of the system.

In this embodiment, a method for training a target volume adjustment probability model is provided, which is applicable to an electronic device, such as a mobile phone, a tablet computer, etc. FIG. 2 is a flowchart of a method for training a target volume adjustment probability model according to an embodiment of the present disclosure, and as shown in FIG. 2, the flow comprises the following steps:
Step S201: obtaining a plurality of media data samples and corresponding historical playback records.

Acquiring a plurality of media data samples and corresponding historical playback records to clarify the volume adjustment situation of the corresponding media data samples during past playbacks based on the historical playback records, and then capturing the relationship between the media data and the volume adjustment at different playback volumes therefrom, so as to facilitate the subsequent improvement of the prediction accuracy of the volume adjustment probability. The source of the plurality of media data samples may be local storage or cloud, and the specifics may be determined according to actual needs.

In some alternative embodiments, the media data types corresponding to the plurality of media data samples comprise at least one type. For example, media data types may comprise, but are not limited to, music, video, voice, and the like. By using multiple types of media data samples for training, the model may learn the characteristics and rules of different types of media, which is beneficial to improve the accuracy of volume adjustment probability prediction for different types of media and meet the volume adjustment requirements of users for media data of different types of media data.
Step S202: based on a historical playback record, determining a loudness adjustment parameter and a volume adjustment probability parameter of a corresponding media data sample.

According to the historical playback records, the historical playback situations of the media data sample may be clarified, and then the loudness adjustment parameters of the media data samples can be obtained by analyzing the volume change in the playback records, and the volume adjustment probability parameters corresponding to the volume adjustment situations under different playback volumes in the actual playback process can be clarified.

The loudness adjustment parameters comprise, but is not limited to, the following parameters: a target loudness, a final gain, a limit compensation gain, a dynamic range control compensation gain, a final dynamic range control compression ratio, and a maximum loudness range of the corresponding media data samples during playback. The volume adjustment probability parameters comprise, but does not limit, a first probability that the playback volume is increased and a second probability that the playback volume is decreased. In some alternative implementation scenarios, the volume adjustment probability parameters may be obtained by on-line buried points corresponding to media data samples, thereby helping to improve determination efficiency.

In some alternative embodiments, the above step S202 comprises:
Step a1, determining, based on the historical playback record, a first playback number of times of the media data sample previously played at a playback volume, a second playback number of times of the media data sample previously played at an increased volume, and a third playback number of times of the media data sample previously played at a reduced volume;
Step a2, determining a first probability of the playback volume being increased during past playbacks of the media data sample based on a ratio of the second playback number of times to the first playback number of times;
Step a3, determining a second probability of the playback volume being reduced during the past playbacks of the media data sample based on a ratio of the third playback number of times to the first playback number of times;
Step a4: determining, based on the first probability and the second probability, the volume adjustment probability parameter of the media data sample played at the playback volume during the past playbacks.

Specifically, a relevant volume adjustment record of the corresponding media data sample previously played is extracted from the historical playback record, and by analyzing the volume adjustment record, the first playback number of times in which the media data sample is played at the playback volume, the second playback number of times in which the volume is increased, and the third playback number of times in which the volume is reduced can be counted respectively.

By dividing the second playback number of times by the first second playback number of times, the first probability of increasing the volume when the media data sample was played previously at the playback volume can be determined. By dividing the third playback number of times by the first playback number of times, the second probability of reducing the volume when the media data sample was played previously at the playback volume can be determined.

According to the first probability and the second probability, the volume adjustment situation of the media data sample played previously at the playback volume can be comprehensively analyzed, and the volume adjustment probability parameter of the media data sample can be obtained, and it is helpful for the model to learn the volume playback preference of the media data when the model is subsequently trained. For example, the volume adjustment probability parameter can be determined by comprehensively analyzing the first probability and the second probability by taking an average or a weighted average.
Step S203: based on media metadata samples of the media data samples and corresponding loudness adjustment parameters and corresponding volume adjustment probability parameters, training a playback volume adjustment probability model to obtain the target volume adjustment probability model.

Using media metadata samples of all media data samples and corresponding loudness adjustment parameters and volume adjustment probability parameters, training the playback volume adjustment probability model, and optimizing the performance of the model by constantly adjusting the parameters of the model in the training process, so that the volume adjustment probability can be predicted more accurately, thus obtaining the target volume adjustment probability model. The playback volume adjustment probability model is constructed based on regression models. Types of regression models comprise, but are not limited to, linear regression models, decision tree regression models, random forest regression models, support vector machine regression models, and the like.

In some alternative embodiments, the above step S203 comprises:
step b1, according to the media metadata sample of the media data sample, determining a first media parameter set of the media data sample during the past playbacks to obtain an input parameter set corresponding to the media data sample by combining with the corresponding loudness adjustment parameter, the first probability and the second probability;
step b2, inputting the input parameter set into the playback volume adjustment probability model for regression processing to obtain an intermediate model;
in step b3, in response to an accuracy of the intermediate model being greater than or equal to a preset threshold, determining that training is complete and using the intermediate model as the target volume adjustment probability model.

Specifically, according to the media metadata sample of the media data sample, the first media parameter set of the media data sample during the past playbacks is determined, and the loudness adjustment parameter, the first probability, and the second probability are combined with the first media parameter set to obtain the input parameter set corresponding to the media data sample. The first media parameter set may comprise a historical media source loudness, a historical loudness range, a starting loudness of the historical loudness range, an end loudness of the historical loudness range, a historical maximum instant loudness, a historical maximum short-time loudness, a historical first low frequency direct speaker compensation gain (e.g., 100 hz), a historical second low frequency direct speaker compensation gain (e.g., 150 hz), a historical third low frequency direct speaker compensation gain (e.g., 200 hz), a historical playback total duration, and a historical target loudness, etc.

The input parameter set is input into the playback volume adjustment probability model for regression processing. The purpose of the regression process is to predict the volume adjustment probability based on the input parameter set. By training a large number of input parameter sets, the playback volume adjustment probability model can gradually learn the relationship between the media metadata samples, the loudness adjustment parameters and the volume adjustment probability, and continuously optimize the parameters of the model to improve the prediction accuracy. During the training process, the accuracy of the intermediate model is constantly calculated. When the accuracy of the intermediate model is greater than or equal to the preset threshold, the model is considered to have been trained. At this time, the intermediate model is used as the target volume adjustment probability model, and can be applied to the actual volume adjustment scene to ensure that the target volume adjustment probability model has sufficient accuracy and reliability, and can provide effective guidance for the actual volume adjustment.

According to the training method of the target volume adjustment probability model according to the present embodiment, by performing regression model training based on historical playback records, the playback volume adjustment probability model can learn the relationship between the media data at different playback volumes and the volume adjustment in the training process, and further the target volume adjustment probability model obtained after training can improve the accuracy of volume adjustment, thereby helping to reduce the occurrence of manual volume adjustment by a user.

In some alternative embodiments, the media metadata comprises a plurality of media information of the target media data in a specified dimension, thereby helping to improve the accuracy of determining the volume adjustment probability. For example, the media metadata comprises a plurality of media information in 12 dimensions of the target media data. The plurality of media information in the 12 dimensions comprise: corresponding media source loudness, loudness range, starting loudness of the loudness range, ending loudness of the loudness range, maximum instant loudness, maximum short-time loudness, 100 hz low frequency direct speaker compensation gain, 150 hz low frequency direct speaker compensation gain, 200 hz low frequency direct speaker compensation gain, total playback duration, current playback duration, and target loudness.

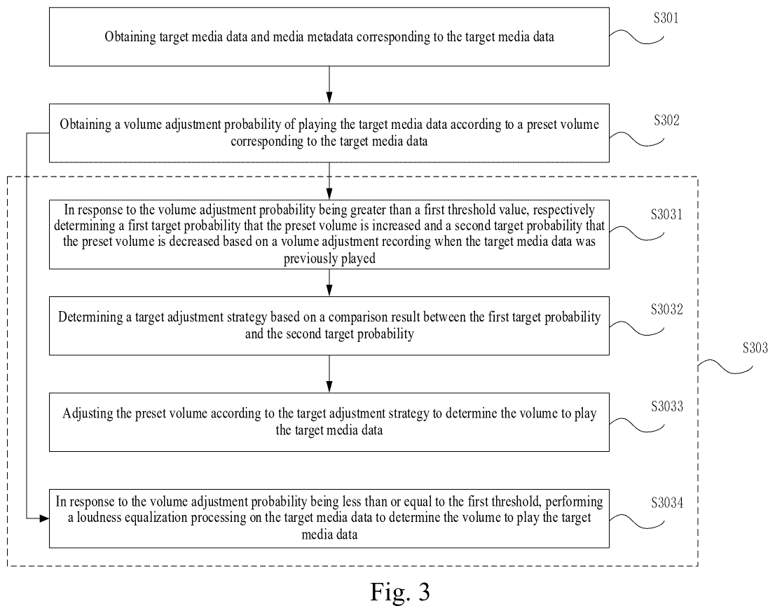

In this embodiment, a volume adjustment method is provided, which is applicable to the electronic device, such as mobile phones, tablet computers, etc. FIG. 3 is a flowchart of the volume adjustment method according to the embodiment of the present disclosure, and as shown in FIG. 3, the flow comprises the following steps:
step S301, obtaining target media data and media metadata corresponding to the target media data.
step S302, obtaining a volume adjustment probability of playing the target media data according to a preset volume corresponding to the target media data.
step S303, based on the volume adjustment probability, adjusting the preset volume to determine a volume to play the target media data.

In some alternative embodiments, the above step S303 comprises:
step S3031, in response to the volume adjustment probability being greater than a first threshold, respectively determining a first target probability that the preset volume is increased and a second target probability that the preset volume is decreased based on a volume adjustment recording when the target media data was previously played.

The first threshold may be understood as a maximum volume adjustment probability value for determining that the preset volume does not need to be adjusted. In response to the volume adjustment probability being greater than the first threshold, the volume may be adjusted when the target media data is played at the preset volume. Therefore, when it is determined that the volume adjustment probability is greater than the first threshold, the first target probability of increasing the preset volume and the second target probability of decreasing the preset volume are respectively determined based on the volume adjustment record, so that the adjustment direction of subsequent adjustment of the preset volume can be determined based on the comparison result of the first target probability and the second target probability, and the effectiveness of the volume adjustment can be improved.
Step S3032: determining a target adjustment strategy based on a comparison result between the first target probability and the second target probability.

According to the comparison result between the first target probability and the second target probability, the adjustment direction can be determined, thus making the resulting target adjustment strategy more reasonable and effective. For example, if the first target probability is greater than the second target probability, it is indicated that the probability that the preset volume was increased is greater than the probability that the preset volume was decreased during the past playbacks of the target media data, and when subsequently determining the target adjustment strategy, it is necessary to adopt an adjustment strategy that may increase the preset volume as the target adjustment strategy. If the first target probability is smaller than the second target probability, it indicates that the probability that the preset volume is increased was smaller than the probability that the preset volume was decreased in the process of historically playing the target media data, and when subsequently determining the target adjustment strategy, it is necessary to adopt an adjustment strategy that may decrease the preset volume as the target adjustment strategy.
Step S3033: adjusting the preset volume according to the target adjustment strategy to determine the volume to play the target media data.

After the target adjustment strategy is determined, the preset volume is adjusted according to the target adjustment strategy, so that the volume to play the obtained target media data is more in line with the playing expectation, and the probability that the volume of the target media data is adjusted in the playing process can be effectively reduced, so that the purpose of improving the playing effect of the media data can be achieved.

In some alternative embodiments, the above step S303 further comprises:
Step S3034: in response to the volume adjustment probability being less than or equal to the first threshold, performing a loudness equalization processing on the target media data to determine the volume to play the target media data.

In response to the volume adjustment probability being less than or equal to the first threshold, it is indicated that the volume adjustment probability of the target media data is low when the target media data is played at the preset volume in the historical playing processes. Therefore, in order to improve the playing quality of the target media data, loudness equalization processing is performed on the target media data to further optimize the audio effect of the target media data and obtain the volume to play the target media data.

In the volume adjustment method according to the present embodiment, after the volume adjustment probability of the target media data being played at the preset volume is determined, the volume to play the target media data is determined in different ways based on the comparison result of the volume adjustment probability and the first threshold, so that the volume adjustment mode can be more flexible and targeted, and thus the playing quality of the target media data can be effectively improved, the probability of manual adjustment can be reduced, and the expectation of the user can be satisfied.

In some alternative embodiments, the determination process of the first target probability may be as follows: according to the volume adjustment record, a playback record in which the volume adjustment is performed when the target media data was played at the preset volume during the historical playback processes may be filtered out, and according to the playback record, the number of playback times to increase the preset volume may be counted to obtain the first adjustment number. The ratio between the first adjustment number and the first playback number of times is set as the first target probability. Similarly, when determining the second target probability, according to the playback record, the number of playback times to reduce the preset volume may be counted to obtain the second adjustment number. The ratio between the second adjustment number and the first playback number of times is set as the second target probability.

In some alternative embodiments, based on the comparison result between the first target probability and the second target probability, the process of determining the target adjustment strategy comprises determining the target adjustment strategy as the first adjustment strategy if a first difference between the first target probability and the second target probability is greater than the second threshold. Here, the second threshold may be understood as a threshold for determining whether the volume increase processing is required. The specific value of the second threshold may be set according to the demand, for example, the second threshold may be 0.4 or 0.5. When the first difference between the first target probability and the second target probability is larger than the second threshold, it is indicated that when the target media data is played at the preset volume in the process of historical playback, the preset volume was adjusted in a manner of increasing the volume in most cases, so as to alleviate the problem that the hearing effect is affected by the small volume provided by the preset volume. Therefore, the first adjustment strategy for increasing the preset volume is selected as the target adjustment strategy, so that when the volume is adjusted subsequently, the preset volume can be increased to meet the playback expectation, and the purpose of improving the playback effect of the target media data is achieved.

In another alternative embodiment, if the target adjustment strategy is the first adjustment strategy, adjusting the preset volume according to the target adjustment strategy to determine the volume to play the target media data comprises: according to the first adjustment strategy, determining a maximum value of the dynamic range control curve, and adjusting the preset volume based on the maximum value to obtain the volume to play the target media data.

Specifically, the maximum value of the Dynamic Range Control (DRC) curve is determined according to the first adjustment strategy. Dynamic range control is a way to adjust the volume by compressing or expanding the dynamic range of audio signals. In order to increase the preset volume as much as possible, the maximum value of the DRC curve is determined, and the preset volume is adjusted by the maximum value, so that the volume to play the target media data can meet the playing expectation.

In still other alternative embodiments, the process of determining the target adjustment strategy based on the comparison result between the first target probability and the second target probability further comprises determining the target adjustment strategy based on a second difference between the second target probability and the first target probability if the first difference between the first target probability and the second target probability is less than or equal to the second threshold. If the first difference between the first target probability and the second target probability is less than or equal to the second threshold, it is indicated that when the historical target media data was played according to the preset volume in the process of historical playback, there are few cases in which the preset volume is adjusted by increasing the volume. Therefore, in order to determine whether there are many cases in which the preset volume was adjusted by decreasing the volume in the process of historical playback, the target adjustment strategy is determined based on the second difference between the second target probability and the first target probability, so as to improve the accuracy of determining the target adjustment strategy.

In some alternative embodiments, if the second difference is greater than a third threshold, the target adjustment strategy is determined as a second adjustment strategy, and the second adjustment strategy is configured to reduce the preset volume; if the second difference is less than or equal to the third threshold, the target adjustment strategy is determined as a third adjustment strategy, and the third adjustment strategy is configured to compress the dynamic range control curve and adjust the preset volume based on the compressed dynamic range control curve.

Specifically, the third threshold may be understood as a threshold for determining whether the volume reduction process is necessary. The specific value of the third threshold may be set according to the demand, for example, the third threshold may be 0.2 or 0.3. If the second difference value is greater than the third threshold, it indicated that when the target media data was played at the preset volume during the historical playback process, the preset volume is adjusted in a manner of reducing the volume in most cases, so as to alleviate the problem that the hearing effect is affected by too large volume provided by the preset volume. Therefore, the second adjustment strategy for reducing the preset volume is selected as the target adjustment strategy, so that when the preset volume is subsequently adjusted according to the second adjustment strategy, the preset volume can be effectively reduced to meet the playback expectation. For example, the second adjustment strategy may refer to reducing the preset volume by adjusting the limit makeup gain or the DRC compensation gain. Preferably, the limit compensation gain or the DRC compensation gain can be adjusted by setting it to zero or adjusting the weight, thereby achieving the purpose of reducing the preset volume, avoiding the occurrence of excessive strong or distortion of the audio signal due to excessive compensation gain, and thereby improving the stability of volume adjustment.

If the second difference value is less than or equal to the third threshold, it is indicated that the preset volume may be increased or decreased when the target media data is played at the preset volume in the process of historical playback. Therefore, the third adjustment strategy is selected as the target adjustment strategy, so that the volume to be played after adjustment can be more stable when the preset volume is adjusted according to the third adjustment strategy. Wherein, the third adjustment strategy is configured to compress the dynamic range control curve and adjust the preset volume based on the compressed dynamic range control curve, so as to effectively avoid the volume fluctuation of the adjusted volume, improve the listening experience of the target media data to a certain extent, make the sound playback clearer and more comfortable, and be conducive to improving the playback quality of the target media data.

Determining the target adjustment strategy according to the comparison result of the second difference value and the third threshold can adapt to different playback situations more flexibly, improve the quality and effect of media data playback, and meet playback expectations.

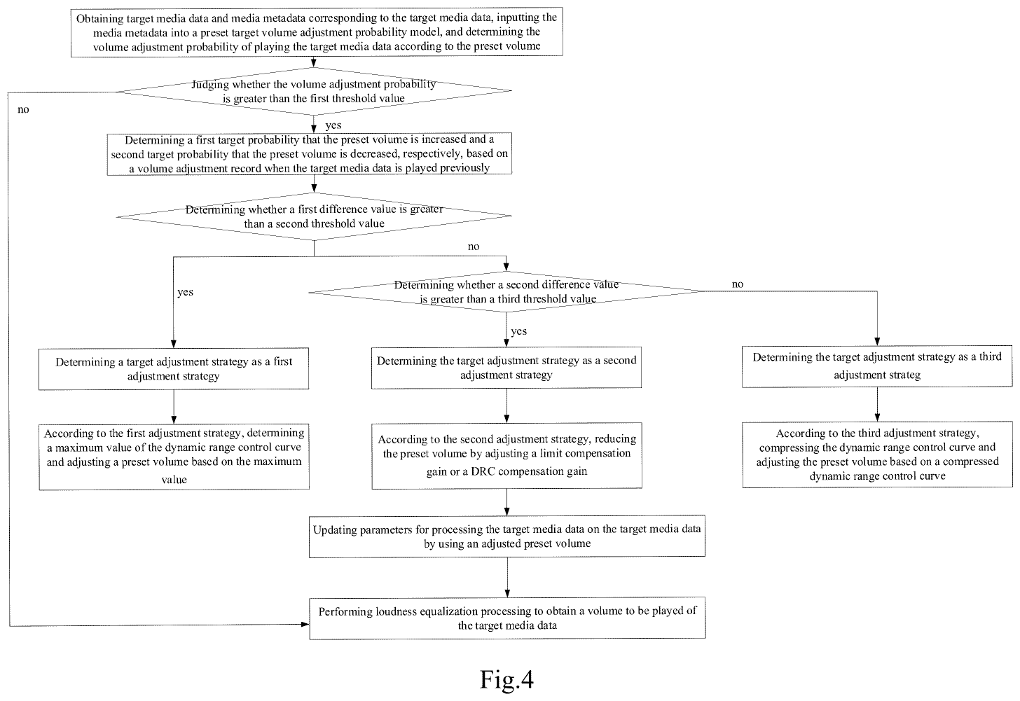

As another specific application embodiment or embodiments of the present disclosure, a process of determining the volume to play the target media data is shown in FIG. 4, and the specific process is as follows:

First, obtaining target media data and media metadata corresponding to the target media data, inputting the media metadata into a preset target volume adjustment probability model, and determining the volume adjustment probability of playing the target media data according to the preset volume.

Secondly, in a case where the volume adjustment probability is determined, the volume adjustment probability is compared with the first threshold, and it is determined whether the volume adjustment probability is greater than the first threshold.

If the volume adjustment probability is less than or equal to the first threshold, the target media data is subjected to loudness equalization processing to determine the volume to play the target media data.

If the volume adjustment probability is greater than the first threshold, a first target probability that the preset volume is increased and a second target probability that the preset volume is decreased are respectively determined based on the volume adjustment recording when the target media data is played back historically. It is determined whether a first difference between the first target probability and the second target probability is greater than a second threshold. If the first difference between the first target probability and the second target probability is greater than the second threshold, the target adjustment strategy is determined as the first adjustment strategy. According to the first adjustment strategy, the maximum value of the dynamic range control curve is determined, and the preset volume is adjusted based on the maximum value, and the parameters for processing the target media data are updated on the target media data by using an adjusted preset volume, and loudness equalization processing is performed by using an updated parameters, so as to determine the volume to play the target media data.

If the first difference between the first target probability and the second target probability is less than or equal to the second threshold, it is determined whether the second difference between the second target probability and the first target probability is greater than a third threshold. If the second difference between the second target probability and the first target probability is greater than the third threshold, the target adjustment strategy is determined as the second adjustment strategy. According to the second adjustment strategy, the preset volume is reduced by adjusting the limit makeup gain or the DRC compensation gain, and then the parameters for processing the target media data are updated on the target media data by using the adjusted preset volume, and loudness equalization processing is performed by using the updated parameters, thereby determining the volume to play the target media data.

If the second difference between the second target probability and the first target probability is less than or equal to the third threshold, the target adjustment strategy is determined as the third adjustment strategy. According to the third adjustment strategy, the dynamic range control curve is compressed and the preset volume is adjusted based on the compressed dynamic range control curve, and then parameters for processing the target media data are updated on the target media data by using the adjusted preset volume, and loudness equalization processing is carried out by using the updated parameters, so as to determine the volume to play the target media data.

By performing the volume adjustment in the above manner, the volume adjustment process can be more scientific and targeted, so that the volume to play the obtained target media data can be more in line with the expectation, and the broadcasting quality and effect of the target media data can be improved.

As another specific application embodiment or embodiments of the present disclosure, the target adjustment strategy may be obtained by being processed by a preset volume adjustment module. The process of processing the target media data comprises parameter preparation stage and stream processing stage. The preparation stage comprises determining loudness gain, determining parameters of the DRC curve, and determining loudness compensation gain. In the preparation stage, a volume adjustment probability for the target media data to be played according to a preset volume is determined in advance based on the target media data and media metadata corresponding to the target media data. In response to the volume adjustment probability being greater than the first threshold, based on the target adjustment strategy determined by the volume adjustment module, the loudness gain in the preparation stage, the parameters of the DRC curve, and the loudness compensation gain are targeted adjusted, so that when the stream processing stage performs loudness gain processing on the target media data, the hearing effect can be more reasonable and the hearing effect can be more satisfied with expectations.

In the stream processing stage, performing loudness gain processing on the target media data by using loudness gain to obtain first media data; using the parameters of the DRC curve to obtain the DRC curve, and then using the DRC curve to perform dynamic range control processing on the first media data to obtain the second media data; performing loudness compensation on the second media data in combination with the loudness compensation gain to obtain the third media data; finally, performing peak limiting on the third media data to obtain the target media data.

In this embodiment, a volume adjustment apparatus is also provided, and the apparatus is configured to realize the above embodiment and the preferred embodiment, and the description thereof will not be repeated. As used below, the term “module” may be a combination of software and/or hardware that implements a predetermined function. Although the apparatus described in the following embodiments is preferably implemented in software, implementations of hardware, or combinations of software and hardware, are also possible and contemplated.

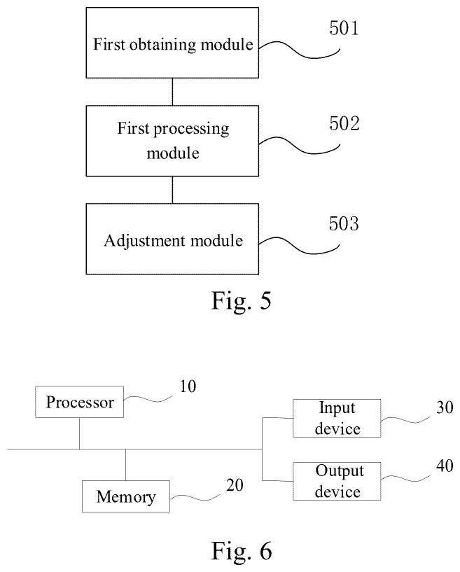

The present embodiment provides a volume adjustment apparatus, as shown in FIG. 5, comprising:
a first obtaining module 501, configured to obtain target media data and media metadata corresponding to the target media data;
a first processing module 502, configured to obtain a volume adjustment probability of playing the target media data according to a preset volume corresponding to the target media data, wherein the volume adjustment probability is obtained based on a regression processing result of the media metadata; and
an adjustment module 503, configured to adjust the preset volume to determine a volume to play the target media data based on the volume adjustment probability.

In some alternative embodiments, the volume adjustment probability is determined based on a preset target volume adjustment probability model, and the target volume adjustment probability model is trained based on regression processing of historical playback records of a plurality of media data samples.

In some alternative embodiments, a training apparatus for the target volume adjustment probability model comprises:
a second obtaining module configured to obtain a plurality of media data samples and corresponding historical playback records;
a second processing module configured to determine a loudness adjustment parameter and a volume adjustment probability parameter of a media data sample based on the historical playback records;
a training module configured to, based on a media metadata sample of the media data sample, a corresponding loudness adjustment parameter and a corresponding volume adjustment probability parameter, train a playback volume adjustment probability model to obtain the target volume adjustment probability model, wherein the playback volume adjustment probability model is constructed based on a regression model.

In some alternative embodiments, the second processing module comprises:
a first processing unit configured to determine, based on the historical playback record, a first playback number of times of the media data sample previously played at a playback volume, a second playback number of times of the media data sample previously played at an increased volume, and a third playback number of times of the media data sample previously played at a reduced volume;
a second processing unit configured to determine a first probability of the playback volume being increased during past playbacks of the media data sample based on a ratio of the second playback number of times to the first playback number of times;
a third processing unit configured to determine a second probability of the playback volume being reduced during the past playbacks of the media data sample based on a ratio of the third playback number of times to the first playback number of times;
a fourth processing unit configured to determine, based on the first probability and the second probability, the volume adjustment probability parameter of the media data sample played at the playback volume during the past playbacks.

In some alternative embodiments, the training module comprises:
a fifth processing unit, configured to according to the media metadata sample of the media data sample, determine a first media parameter set of the media data sample during the past playbacks to obtain an input parameter set corresponding to the media data sample by combining with the corresponding loudness adjustment parameter, the first probability and the second probability;
a sixth processing unit configured to input the input parameter set into the playback volume adjustment probability model for regression processing to obtain an intermediate model;
a seventh processing unit configured to in response to an accuracy of the intermediate model being greater than or equal to a preset threshold, determining that training is complete and using the intermediate model as the target volume adjustment probability model.

In some alternative embodiments, the media data types corresponding to the plurality of media data samples include at least one type.

In some alternative embodiments, the media metadata includes a plurality of media information of the target media data in a specified dimension.

In some alternative embodiments, the adjustment module 503 comprises:
an eighth processing unit configured to, in response to the volume adjustment probability being greater than a first threshold, determine, respectively, a first target probability that the preset volume is increased and a second target probability that the preset volume is decreased based on a volume adjustment recording when the target media data was previously played;
a strategy determination unit configured to determine a target adjustment strategy based on a comparison result between the first target probability and the second target probability;
a volume adjustment unit configured to adjust the preset volume according to the target adjustment strategy to determine the volume to play the target media data.

In some alternative embodiments, the strategy determination unit comprises:
a first execution unit configured to in response that a first difference between the first target probability and the second target probability is greater than a second threshold, determine the target adjustment strategy as a first adjustment strategy, and the first adjustment strategy is configured to increase the preset volume.

In some alternative embodiments, the volume adjustment unit comprises:
a second execution unit configured to, according to the first adjustment strategy, determine a maximum value of the dynamic range control curve, and adjusting the preset volume based on the maximum value to obtain the volume to play the target media data.

In some alternative embodiments, the strategy determination unit further comprises:
a third execution unit configured to, in response that a first difference between the first target probability and the second target probability is less than or equal to the second threshold, determine the target adjustment strategy based on a second difference between the second target probability and the first target probability.

In some alternative embodiments, the third execution unit comprises:
a first determination unit configured to, in response that the second difference value is greater than a third threshold, determine the target adjustment strategy as a second adjustment strategy, and the second adjustment strategy is configured to reduce the preset volume;
a second determination unit configured to, in response that the second difference is less than or equal to the third threshold, determine the target adjustment strategy as a third adjustment strategy, and the third adjustment strategy is configured to compress a dynamic range control curve and adjust the preset volume based on a compressed dynamic range control curve.

In some alternative embodiments, the adjustment module 503 further comprises:
a ninth processing module configured to, in response to the volume adjustment probability being less than or equal to the first threshold, perform loudness equalization processing on the target media data to determine the volume to play the target media data.

Further functional descriptions of the above-described modules and units are the same as those of the above-described corresponding embodiments, and will not be repeatedly described herein.

The volume adjustment device in this embodiment is presented in the form of a functional unit, and the unit here refers to an ASIC (Application Specific Integrated Circuit) circuit, processor and memory that execute one or more software or fixed programs, and/or other devices that can provide the above-described functions.

The embodiment of the present disclosure further provides an electronic device comprising the volume adjustment apparatus shown in FIG. 5.

Referring to FIG. 6, FIG. 6 is a schematic structural diagram of an electronic device according to an alternative embodiment of the present disclosure. As shown in FIG. 6, the electronic device comprises one or more processor 10, memory 20, and interfaces for connecting various components, comprising a high-speed interface and a low-speed interface. The various components are communicatively connected to each other using different buses and may be mounted on a common motherboard or otherwise as desired. The processor may process instructions executed within the electronic device, comprising instructions stored in or on the memory to display graphical information of the GUI on an external input/memory, such as a display device coupled to the interface. In some alternative embodiments, a plurality of processor and/or a plurality of buses may be used with a plurality of memory and a plurality of memory if desired. Likewise, multiple electronic device devices may be connected, with each device providing some of the necessary operations (e.g., as an array of servers, a set of blade servers, or a multi-processor system). In FIG. 6, a processor 10 is taken as an example.

Processor 10 may be central processing unit, Cyber processor, or a combination thereof. Among them, the processor 10 may further comprise a hardware chip. The hardware chip may be an application specific integrated circuit, a programmable logic device, or a combination thereof. The programmable logic device may be a complex programmable logic device, a field programmable logic gate array, a general purpose array logic, or any combination thereof.

The memory 20 stores instructions executable by the at least one processor 10 to cause the at least one processor 10 to perform the method illustrated in the embodiment described above.

The memory 20 may comprise a stored program area and a stored data area, wherein the stored program area may store operating system and application required for at least one function; the storage data area may store data or the like created in accordance with the use of electronic device. Furthermore, the memory 20 may comprise a high-speed random access memory, and may also comprise a non-transitory memory, such as at least one magnetic disk memory device, a flash memory device, or other non-transitory solid state memory device. In some alternative embodiments, the memory 20 may optionally comprise a memory located remotely relative to the processor 10 to which the remote memory may be connected via a network. Examples of the above networks comprise, but are not limited to, the Internet, an enterprise intranet, a local area network, a mobile communication network, and combinations thereof.

Memory 20 may comprise a volatile memory, for example, a random access memory; memory may also comprise a non-volatile memory, for example, a flash memory, a hard disk, or a solid state hard disk; the memory 20 may also comprise a combination of the above-described kinds of memory.

The electronic device also comprises input apparatus 30 and output apparatus 40. Processor 10, memory 20, input apparatus 30, and output apparatus 40 may be connected by a bus or other means, as illustrated in FIG. 6 by a bus connection.

The input apparatus 30 may receive input numeric or character information and generate key signal inputs related to user settings and functional controls of the electronic device, such as a touchscreen, keypad, mouse, trackpad, touchpad, pointer lever, one or more mouse buttons, trackball, joystick, etc. The output apparatus 40 may comprise a display device, an auxiliary lighting device (e.g., an LED), a tactile feedback device (e.g., a vibration motor), and the like. The above display devices comprise, but are not limited to, liquid crystal displays, light emitting diodes, displays, and plasma displays. In some alternative embodiments, the display device may be a touchscreen.

Embodiments of the present disclosure also provide a computer-readable storage medium, and the above-described methods according to embodiments of the present disclosure can be implemented in hardware, firmware, or as computer code that can be recorded in storage medium, or downloaded over a network and is originally stored in a remote storage medium or a non-transitory machine-readable storage medium and to be stored in a local storage medium, so that the methods described herein can be processed by such software stored on a processor using a general-purpose computer, a special-purpose storage medium, or programmable or special-purpose hardware. Wherein, the storage medium can be magnetic disk, optical disk, read-only memory, random access memory, flash memory, hard disk or solid-state hard disk, etc.; further, the storage medium may also comprise a combination of the above-described kinds of memory. It will be appreciated that a computer, processor, microprocessor controller, or programmable hardware comprises a storage component that may store or receive software or computer code that, when accessed and executed by the computer, processor, or hardware, implements the methods illustrated in the above embodiments.

Part of the present invention may be applied to computer program product, such as computer program instructions, when executed by a computer, by operation of which the method and/or technical solution according to the present invention can be invoked or provided. Those skilled in the art will understand that the existence forms of computer program instructions in a computer-readable medium comprise, but are not limited to, source files, executable file, installation package files, etc. Accordingly, the manner in which computer program instructions are executed by a computer comprises, but is not limited to: the computer directly executes the instructions, or the computer compiles the instructions and then executes the corresponding compiled program, or the computer reads and installs the instructions and then executes the corresponding post-installation program. Here, the computer-readable medium may be any available computer-readable storage medium or communication medium accessible by a computer.

It can be understood that before using the technical solutions disclosed in each embodiment of the present disclosure, users should be informed of the types, usage scope, usage scenarios, etc. of the personal information involved in the present disclosure in an appropriate manner in accordance with relevant laws and regulations, and authorization from the users should be obtained.

For example, in response to receiving an active request from the user, prompt information is sent to the user to explicitly prompt the user that the operation it requests to perform will require the acquisition and use of the user's personal information. Accordingly, the user can autonomously select whether or not to provide personal information to software or hardware such as electronic device, application, a server, or storage medium that performs the operation of the technical solution of the present disclosure according to prompt information.

As an optional but non-limiting implementation, in response to receiving an unsolicited request from the user, the manner of sending prompt information to the user may be, for example, the manner of pop-up window, and the pop-up window may be presented in text in the prompt information. In addition, the pop-up window can also carry an optional control for users to choose “agree” or “disagree” to provide personal information to electronic device.

It is to be understood that the above-described procedures of notifying and obtaining user authorization are merely illustrative and do not limit the implementation forms of the present disclosure, and other methods satisfying relevant laws and regulations can also be applied to the implementation forms of the present disclosure.

Although embodiments of the present disclosure have been described in conjunction with the accompanying drawings, various modifications and variations can be made by those skilled in the art without departing from the spirit and scope of the present disclosure, and such modifications and variations fall within the scope defined by the appended claims.

1. A method for volume adjustment, comprising:
obtaining target media data and media metadata corresponding to the target media data;
obtaining a volume adjustment probability of playing the target media data according to a preset volume corresponding to the target media data, wherein the volume adjustment probability is obtained based on a regression processing result of the media metadata; and
adjusting the preset volume based on the volume adjustment probability, to determine a volume to play the target media data.

2. The method of claim 1, wherein the volume adjustment probability is determined based on a preset target volume adjustment probability model, and the target volume adjustment probability model is trained based on performing regression processing on historical playback records of a plurality of media data samples.

3. The method of claim 2, wherein a process of training the target volume adjustment probability model comprises:
obtaining the media data samples and the historical playback records corresponding to the media data samples;
based on each historical playback record of the historical playback records, determining a loudness adjustment parameter and a volume adjustment probability parameter of a media data sample corresponding to the historical playback record; and
based on a media metadata sample of the media data sample, and the loudness adjustment parameter and the volume adjustment probability parameter corresponding to the media data sample, training a playback volume adjustment probability model to obtain the target volume adjustment probability model, wherein the playback volume adjustment probability model is constructed based on a regression model.

4. The method of claim 3, wherein the based on each historical playback record of the historical playback records, determining a volume adjustment probability parameter of a media data sample corresponding to the historical playback record comprises:
determining, based on the historical playback record, a first playback number of times of the media data sample previously played at a playback volume, a second playback number of times of the media data sample previously played at an increased volume, and a third playback number of times of the media data sample previously played at a reduced volume;
determining a first probability of the playback volume being increased during past playbacks of the media data sample based on a ratio of the second playback number of times to the first playback number of times;
determining a second probability of the playback volume being reduced during the past playbacks of the media data sample based on a ratio of the third playback number of times to the first playback number of times; and
determining, based on the first probability and the second probability, the volume adjustment probability parameter of the media data sample played at the playback volume during the past playbacks.

5. The method according to claim 4, wherein the based on a media metadata sample of the media data sample, and the loudness adjustment parameter and the volume adjustment probability parameter corresponding to the media data sample, training a playback volume adjustment probability model to obtain the target volume adjustment probability model comprises:
according to the media metadata sample of the media data sample, determining a first media parameter set of the media data sample during the past playbacks to obtain an input parameter set corresponding to the media data sample by combining with the loudness adjustment parameter, the first probability and the second probability;
inputting the input parameter set into the playback volume adjustment probability model for regression processing to obtain an intermediate model; and
in response to an accuracy of the intermediate model being greater than or equal to a preset threshold, determining that training is complete and using the intermediate model as the target volume adjustment probability model.

6. The method of claim 3, wherein a media data type corresponding to the plurality of media data samples comprises at least one type.

7. The method of claim 1, wherein the media metadata comprises multiple pieces of media information of the target media data in a specified dimension.

8. The method of claim 1, wherein the adjusting the preset volume based on the volume adjustment probability, to determine a volume to play the target media data comprises:
in response to the volume adjustment probability being greater than a first threshold, respectively determining, based on a volume adjustment recording of the target media data being previously played, a first target probability that the preset volume is increased, and a second target probability that the preset volume is decreased;
determining a target adjustment strategy based on a comparison result between the first target probability and the second target probability; and
adjusting the preset volume according to the target adjustment strategy to determine the volume to play the target media data.

9. The method of claim 8, wherein the determining a target adjustment strategy based on a comparison result between the first target probability and the second target probability comprises:
in response to a first difference between the first target probability and the second target probability being greater than a second threshold, determining the target adjustment strategy as a first adjustment strategy, the first adjustment strategy being configured to increase the preset volume.

10. The method of claim 9, wherein the adjusting the preset volume according to the target adjustment strategy to determine the volume to play the target media data comprises:
according to the first adjustment strategy, determining a maximum value of a dynamic range control curve, and adjusting the preset volume based on the maximum value to obtain the volume to play the target media data.

11. The method of claim 9, wherein the determining a target adjustment strategy based on a comparison result between the first target probability and the second target probability further comprises:
in response to the first difference between the first target probability and the second target probability being less than or equal to the second threshold, determining the target adjustment strategy based on a second difference between the second target probability and the first target probability.

12. The method of claim 11, wherein the determining a target adjustment strategy based on a comparison result between the first target probability and the second target probability further comprises:
in response to the second difference value being greater than a third threshold, determining the target adjustment strategy as a second adjustment strategy, the second adjustment strategy being configured to reduce the preset volume; and
in response to the second difference being less than or equal to the third threshold, determining the target adjustment strategy as a third adjustment strategy, the third adjustment strategy being configured to compress a dynamic range control curve and adjust the preset volume based on a compressed dynamic range control curve.

13. The method of claim 8, wherein the adjusting the preset volume based on the volume adjustment probability, to determine a volume to play the target media data, further comprises:
in response to the volume adjustment probability being less than or equal to the first threshold, performing loudness equalization processing on the target media data to determine the volume to play the target media data.

14. An electronic device comprising:
a processor; and
a memory, configured to store computer instructions,
wherein the computer instructions, when executed by the processor, cause the processor to perform a method for volume adjustment, comprising:
obtaining target media data and media metadata corresponding to the target media data;
obtaining a volume adjustment probability of playing the target media data according to a preset volume corresponding to the target media data, wherein the volume adjustment probability is obtained based on a regression processing result of the media metadata; and
adjusting the preset volume based on the volume adjustment probability, to determine a volume to play the target media data.

15. The electronic device of claim 14, wherein the volume adjustment probability is determined based on a preset target volume adjustment probability model, and the target volume adjustment probability model is trained based on performing regression processing on historical playback records of a plurality of media data samples.

16. The electronic device of claim 15, wherein a process of training the target volume adjustment probability model comprises:
obtaining the media data samples and the historical playback records corresponding to the media data samples;
based on each historical playback record of the historical playback records, determining a loudness adjustment parameter and a volume adjustment probability parameter of a media data sample corresponding to the historical playback record; and
based on a media metadata sample of the media data sample, and the loudness adjustment parameter and the volume adjustment probability parameter corresponding to the media data sample, training a playback volume adjustment probability model to obtain the target volume adjustment probability model, wherein the playback volume adjustment probability model is constructed based on a regression model.

17. The electronic device of claim 16, wherein the based on each historical playback record of the historical playback records, determining a volume adjustment probability parameter of a media data sample corresponding to the historical playback record comprises:
determining, based on the historical playback record, a first playback number of times of the media data sample previously played at a playback volume, a second playback number of times of the media data sample previously played at an increased volume, and a third playback number of times of the media data sample previously played at a reduced volume;
determining a first probability of the playback volume being increased during past playbacks of the media data sample based on a ratio of the second playback number of times to the first playback number of times;
determining a second probability of the playback volume being reduced during the past playbacks of the media data sample based on a ratio of the third playback number of times to the first playback number of times; and
determining, based on the first probability and the second probability, the volume adjustment probability parameter of the media data sample played at the playback volume during the past playbacks.

18. The electronic device according to claim 17, wherein the based on a media metadata sample of the media data sample, and the loudness adjustment parameter and the volume adjustment probability parameter corresponding to the media data sample, training a playback volume adjustment probability model to obtain the target volume adjustment probability model comprises:
according to the media metadata sample of the media data sample, determining a first media parameter set of the media data sample during the past playbacks to obtain an input parameter set corresponding to the media data sample by combining with the loudness adjustment parameter, the first probability and the second probability;
inputting the input parameter set into the playback volume adjustment probability model for regression processing to obtain an intermediate model; and
in response to an accuracy of the intermediate model being greater than or equal to a preset threshold, determining that training is complete and using the intermediate model as the target volume adjustment probability model.

19. The electronic device of claim 14, wherein the adjusting the preset volume based on the volume adjustment probability, to determine a volume to play the target media data comprises:
in response to the volume adjustment probability being greater than a first threshold, respectively determining, based on a volume adjustment recording of the target media data being previously played, a first target probability that the preset volume is increased, and a second target probability that the preset volume is decreased;
determining a target adjustment strategy based on a comparison result between the first target probability and the second target probability; and
adjusting the preset volume according to the target adjustment strategy to determine the volume to play the target media data.

20. A non-transitory computer-readable storage medium, wherein computer instructions are stored on the computer-readable storage medium, and the computer instructions, when executed by a computer processor, cause the computer processor to perform a method for volume adjustment, comprising:
obtaining target media data and media metadata corresponding to the target media data;
obtaining a volume adjustment probability of playing the target media data according to a preset volume corresponding to the target media data, wherein the volume adjustment probability is obtained based on a regression processing result of the media metadata; and
adjusting the preset volume based on the volume adjustment probability, to determine a volume to play the target media data.
